(19) United States
(12) Patent Application Publication
(10) Pub. No.: US 2024/0085105 A1
(43) Pub. Date: Mar. 14, 2024

(54) DIELECTRIC DRYING METHOD AND DIELECTRIC DRYING DEVICE FOR CERAMIC FORMED BODIES, AND METHOD FOR PRODUCING CERAMIC STRUCTURES

(71) Applicant: NGK INSULATORS, LTD., Nagoya-City (JP)

(72) Inventors: Yoshimasa FUMA, Ichinomiya-Shi (JP); Yuichi TAJIMA, Nagoya-Shi (JP)

(73) Assignee: NGK INSULATORS, LTD., Nagoya-City (JP)

(21) Appl. No.: 18/513,900

(22) Filed: Nov. 20, 2023

Related U.S. Application Data
(63) Continuation of application No. PCT/JP2021/036518, filed on Oct. 1, 2021.

(30) Foreign Application Priority Data
Jun. 9, 2021 (JP) 2021-096919

(51) Int. Cl. F26B 3/347; F26B 15/18

(52) U.S. Cl. CPC F26B 3/347; F26B 15/18; F26B 2210/02

(57) ABSTRACT

A dielectric drying method for ceramic formed bodies includes drying a plurality of ceramic formed bodies placed side by side in an arrangement direction Y perpendicular to a conveying direction X on an upper surface of a drying table by conveying the ceramic formed bodies between electrodes of an upper electrode and a lower electrode, and applying a high frequency between the electrodes. The drying table is conveyed by a conveyor having at least one conveyor belt for supporting a portion of the drying table in the arrangement direction Y. At least one electric field adjusting member is arranged below the drying table that is not supported by the conveyor belt.

### CROSS REFERENCE TO RELATED APPLICATIONS

The present invention claims the benefit of priorities to Japanese Patent Application No 2021-096919 filed on Jun. 9, 2021 and PCT Patent Application No. PCT/JP2021/036518 filed on Oct. 1, 2021, the entire contents of which are incorporated herein by reference in its entirety.

### FIELD OF THE INVENTION

The present invention relates to a dielectric drying method and a dielectric drying device for ceramic formed bodies, and a method for producing ceramic structures.

### BACKGROUND OF THE INVENTION

Ceramic structures are used for various applications. For example, honeycomb-shaped ceramic structures having partition walls that define a plurality of cells each extending from a first end face to a second end face are widely used for catalyst supports, diesel particulate filters (DPFs), gasoline particulate filters (GPFs), and the like.

The ceramic structure is produced by forming a green body containing a ceramic raw material to obtain a ceramic formed body, and then drying and firing the ceramic formed body. As used herein, a state after extrusion molding and before drying is referred to as a ceramic formed body, and a state after firing is referred to as a ceramic structure.

Dielectric drying is generally used as a method for drying the ceramic formed body. According to the dielectric drying, the ceramic formed body can be placed between a pair of electrodes, a current can be conducted through the electrodes to subject a dipole of water in the ceramic formed body to molecular movement, and the ceramic formed body can be dried by the frictional heat. As used herein, the “dielectric drying” means high-frequency dielectric drying (a frequency of from about 1 to 100 MHz) that involves arranging an object to be dried between the pair of electrodes to perform drying, but it does not include microwave drying (a frequency of from about 300 MHz to 300 GHz) that involves emitting electromagnetic waves from an oscillator to the object to be dried to perform drying.

However, the dielectric drying is difficult to dry uniformly the ceramic formed body, causing problems of generating cracks and the like during firing, or resulting in non-uniform dimensions of the ceramic structure. Therefore, various measures have been taken for the dielectric drying.

For example, Patent Literature 1 proposes a method for drying a honeycomb formed body (ceramic formed body) using a drying table in which a certain region including a portion contacted with an opened lower end face of the honeycomb formed body is used as a perforated plate, because when the honeycomb formed body is placed on the drying table and dielectrically dried, a high moisture region is generated near upper and lower end faces.

Further, Patent Literature 2 proposes a method for drying honeycomb formed bodies (ceramic formed bodies) by dividing electrodes provided above upper end faces and below lower end faces of the honeycomb formed bodies into a plurality of electrodes at positions corresponding to the upper and lower end faces, respectively, and intermittently moving the honeycomb formed bodies for each pair of electrode units, in order to suppress variations in drying of the honeycomb formed bodies continuously conveyed by a conveyor.

Further, Patent Literature 3 proposes a method for drying a honeycomb formed body while rotating it around its longitudinal axis between a pair of electrodes, in order to dry uniformly the honeycomb formed body.

On the other hand, Patent Literature 4 discloses a technique for suppressing uneven thawing by changing an area of an electrode depending on thawing states of frozen foods, although it relates to a high frequency thawing device for frozen foods.

### PRIOR ART

### Patent Literatures

[Patent Literature 1] Japanese Patent Application Publication No. S60-37382 B
[Patent Literature 2] Japanese Patent Application Publication No. H05-105501 A
[Patent Literature 3] Japanese Patent Application Publication No. H06-298563 A
[Patent Literature 4] Japanese Patent No. 4630189 B

### SUMMARY OF THE INVENTION

The present invention relates to a dielectric drying method for ceramic formed bodies, the method comprising drying a plurality of ceramic formed bodies placed side by side in an arrangement direction Y perpendicular to a conveying direction X on an upper surface of a drying table by conveying the ceramic formed bodies between electrodes of an upper electrode and a lower electrode, and applying a high frequency between the electrodes,
wherein the drying table is conveyed by a conveyor having at least one conveyor belt for supporting a portion of the drying table in the arrangement direction Y; and
wherein at least one electric field adjusting member is arranged below the drying table that is not supported by the conveyor belt.

Further, the present invention relates to a method for producing ceramic structures, comprising the dielectric drying method for the ceramic formed bodies.

Furthermore, the present invention relates to a dielectric drying device for ceramic formed bodies, the device comprising:
an upper electrode;
a lower electrode; and
a conveyer comprising at least one conveyer belt for supporting a portion of a drying table on which a plurality of ceramic formed bodies are placed side by side in an arrangement direction Y perpendicular to a conveying direction X, the conveyer being capable of conveying the plurality of ceramic formed bodies between electrodes of the upper electrode and the lower electrode by the conveyer belt; and
at least one electric field adjusting member arranged below the drying table that is not supported by the conveyor belt.

### BRIEF DESCRIPTION OF THE DRAWINGS

FIG. 1 is a schematic view of a dielectric drying device suitable for use in a dielectric drying method for ceramic formed bodies according to an embodiment of the present invention in a conveying direction X;

FIG. 2 is a schematic view of the dielectric drying device of FIG. 1 in an arrangement direction Y;

FIG. 3 is a schematic view of another dielectric drying device in an arrangement direction Y;

FIG. 4 is a schematic view of the dielectric drying device in FIG. 2 in which other electric field adjusting members are arranged; and

FIG. 5 is a graph showing a relationship between a position of ceramic formed bodies in an arrangement direction Y and a distribution ratio of heating amounts.

### DETAILED DESCRIPTION OF THE INVENTION

The dielectric drying of the ceramic formed body is carried out by placing a plurality of (for example, 2 to 5) ceramic formed bodies side by side in an arrangement direction Y perpendicular to a conveying direction X on an upper surface of the drying table, continuously conveying the drying table between the upper electrode and the lower electrode by a conveyor and applying a high frequency. The conveyor has one or more conveyor belts for supporting a portion of the drying table in the arrangement direction Y.

However, although the method described in Patent Literature 1 can suppress a variation in the dried state of the upper portion and the lower portion of the single ceramic formed body placed on the drying table, it is difficult to suppress a variation in the dried state in the arrangement direction Y (width direction of the drying table). Actually, in the arrangement direction Y, the portion supported by the conveyor belt tends to have a locally increased electric field intensity and an increased amount of drying shrinkage. On the other hand, the portion that is not supported by the conveyor belt tends to have a decreased electric field intensity and a decreased amount of drying shrinkage. As a result, the dry state varies depending on different positions of the ceramic formed bodies arranged side by side in the arrangement direction Y.

Further, the method described in Patent Literature 2 is intended to suppress variations in the drying states of the ceramic formed bodies placed on a plurality of drying tables in the conveying direction X. However, it is not intended to suppress variations in the dry states of the plurality of ceramic formed bodies in the arrangement direction Y.

Further, since the method described in Patent Literature 3 is used in a batch furnace, it is difficult to apply this method to a continuous furnace premised on mass production.

The present invention has been made to solve the above problems. An object of the present invention is to provide a dielectric drying method and a dielectric drying device for ceramic formed bodies, which can suppress variations in the dried states of a plurality of ceramic formed bodies placed on the drying table, in the arrangement direction Y perpendicular to the conveying direction X.

Another object of the present invention is to provide a method for producing ceramic structures capable of making the ceramic structures having a uniform shape.

As a result of intensive studies for the dielectric drying of a plurality of ceramic formed bodies placed side by side in the arrangement direction Y perpendicular to the conveying direction X on the upper surface of the drying table, the present inventors have found that the above problems can be solved by placing one or more electric field adjusting members below the drying tables that are not supported by the conveyor belts in the arrangement direction Y, and have completed the present invention.

According to the present invention, it is possible to provide a dielectric drying method and a dielectric drying device for ceramic formed bodies, which can suppress variations in the dried states of a plurality of ceramic formed bodies placed on the drying table, in the arrangement direction Y perpendicular to the conveying direction X.

Further, according to the present invention, it is possible to provide a method for producing ceramic structures capable of making the ceramic structures having a uniform shape.

Hereinafter, embodiments according to the present invention will be specifically described. It is to understand that the present invention is not limited to the following embodiments, and various modifications and improvements, which will be within the scope of the present invention, may be made based on ordinary knowledge of a person skilled in the art, without departing from the spirit of the present invention.

### (1) Dielectric Drying Method and Dielectric Drying Device for Ceramic Formed Bodies

A dielectric drying method for ceramic formed bodies according to an embodiment of the present invention is carried out by drying a plurality of ceramic formed bodies placed side by side in an arrangement direction Y perpendicular to a conveying direction X on an upper surface of a drying table by conveying the ceramic formed bodies between an upper electrode and a lower electrode (between electrodes), and applying a high frequency between the electrodes.

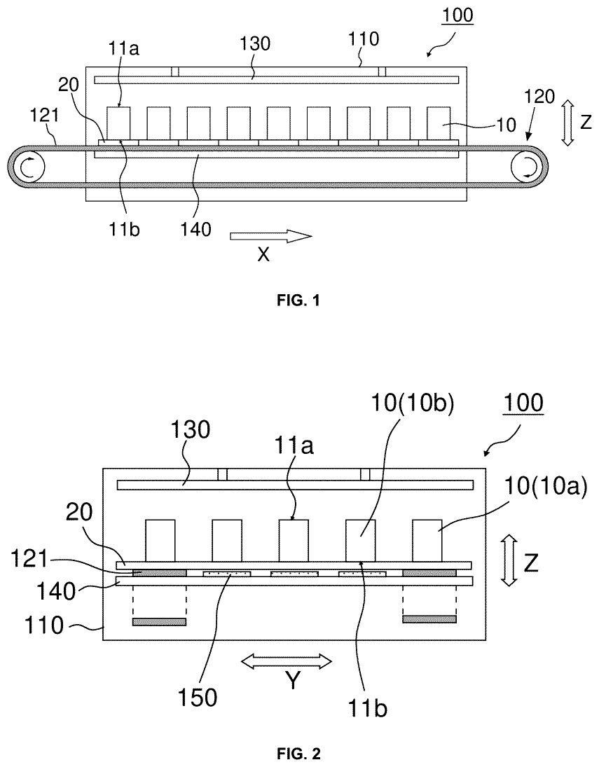

FIG. 1 shows a schematic view of a dielectric drying device suitable for use in the dielectric drying method for the ceramic formed bodies in the conveying direction X. Further, FIG. 2 shows a schematic view of the dielectric drying device in the arrangement direction Y.

As shown in FIGS. 1 and 2, a dielectric drying device 100 includes: an upper electrode 130; a lower electrode 140; a conveyer 120 having at least one conveyer belt 121 for supporting a portion of a drying table 20 on which a plurality of ceramic formed bodies 10 are placed side by side in an arrangement direction Y perpendicular to a conveying direction X, the conveyer 120 being capable of conveying the plurality of ceramic formed bodies 10 between the electrodes of the upper electrode 130 and the lower electrode 140 by the conveyer belt 21; and at least one electric field adjusting member 150 arranged below the drying table 20 that is not supported by the conveyor belt 121. The upper electrode 130 is provided above a dielectric drying furnace 110, and the lower electrode 140 is provided below the dielectric drying furnace 110. Also, the dielectric drying device 100 may further include a known structure (for example, a ventilation drying device) as long as the effect of the present invention is not impaired.

The plurality of ceramic formed bodies 10 placed on the drying table 20 are conveyed between the electrodes of the upper electrode 130 and the lower electrode 140 in the dielectric drying furnace 110 by the conveyer belt 121 of the conveyer 120. In this case, the dipole of water in the ceramic formed bodies 10 is subjected to molecular movement by the high frequency energy generated by passing an electric current between the upper electrode 130 and the lower electrode 140, and the ceramic formed bodies 10 can be dried by that frictional heat.

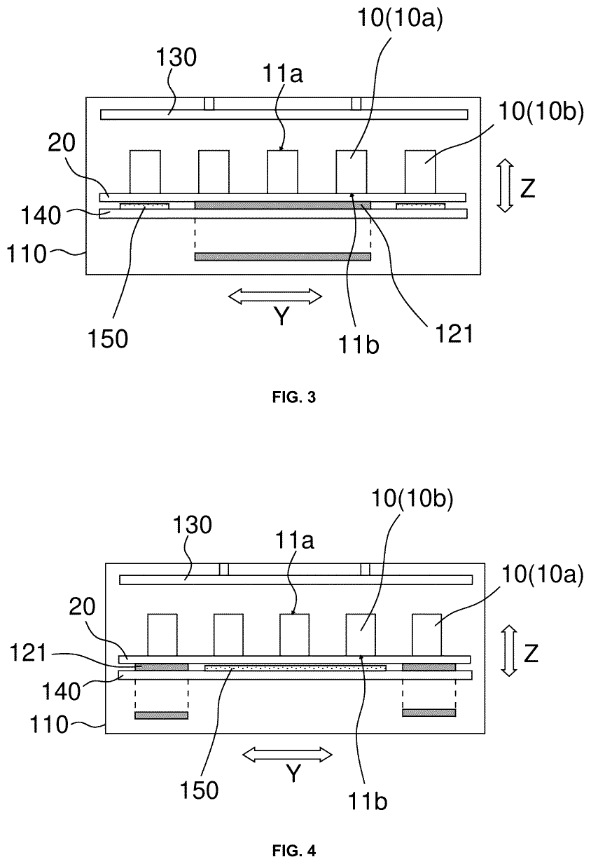

The conveyor belt 121 of the conveyor 120 is shorter than the length of the drying table 20 in the arrangement direction Y although it depends on the type of the conveyor 120, and supports a part of the drying table 20 in the arrangement direction Y. Therefore, a space is created below the drying table 20 that is not supported by the conveyor belt 121. For example, the conveyor belt 121 of the conveyor 120 can be two conveyor belts 121 supporting the vicinity of both ends of the drying table 20 in the arrangement direction Y, as shown in FIG. 2. Alternatively, the conveyor belt 121 of the conveyor 120 can be one conveyor belt 121 supporting the center of the arrangement direction Y of the drying table 20, as shown in FIG. 3. The number and position of the conveyor belts 121 are not limited to the specific examples shown in FIGS. 2 and 3.

When the plurality of ceramic formed bodies 10 placed on the drying table 20 are conveyed between the electrodes of the upper electrode 130 and the lower electrode 140 by the conveyor belt 121 as described above, the electrical field intensity in the ceramic formed body 10b placed on the drying table 20 that is not supported by the conveyor belt 121 is lower than that in the ceramic formed body 10a placed on the drying table 20 supported by the conveyor belt 121, so that the drying state of the plurality of ceramic formed bodies 10 varies in the arrangement direction Y.

Therefore, in an embodiment of the present invention, at least one electric field adjusting member 150 is disposed in the space below the drying table 20 that is not supported by the conveyor belt 121. The arrangement of the electric field adjusting member 150 in such a position provides substantially the same degree of electric field intensity in the arrangement direction Y, so that the variations in the drying states of the plurality of ceramic formed bodies 10 in the arrangement direction Y can be suppressed.

The electric field adjusting member 150 is not limited as long as it is capable of adjusting the electric field intensity, but it may preferably be a plate material having a thickness of more than or equal to 20% and less than 100% of the thickness of the conveyor belt 121. Such a plate material can be easily placed in the space below the drying table 20 that is not supported by the conveyor belt 121. The thickness of the conveyor belt 121 is not particularly limited, but it is, for example, 10 to 50 mm.

A plurality of the electric field adjusting members 150 may be divided and arranged in the space below the drying table 20 that is not supported by the conveyor belt 121 as shown in FIG. 2, but one electric field adjusting member 150 may be arranged in the space as shown in FIG. 4. When the electric field adjusting members 150 are divided and arranged, the length of each of the electric field adjusting members 150 in the arrangement direction Y is preferably equal to or larger than the length of the ceramic formed body 10 in the arrangement direction Y.

The electric field adjusting member 150 is preferably disposed in a region corresponding to an upper position of the upper ceramic formed body 10b in a vertical direction Z (the space below the drying table 20). By thus arranging the electric field adjusting member 150, the variation in the electric field intensity in the arrangement direction Y can be stably suppressed.

The electric field adjusting member 150 is preferably configured from one or more selected from conductors and insulators having a relative permittivity of 1.0 or more. By configuring the electric field adjusting member 150 from the conductor, the electric field adjusting member 150 functions as a part of the lower electrode 140, and the distance between the electrodes is shorter in the region where the electric field adjusting member 150 is present. As a result, the electric field intensity increases in the region where the electric field adjusting member 150 is located, so that the variation in the electric field intensity in the arrangement direction Y can be suppressed. Also, by configuring the electric field adjusting member 150 from the insulator having a relative permittivity of 1.0 or more, electricity can be induced to the region where the electric field adjusting member 150 is arranged. As a result, the electric field intensity in that region increases, and the variation in the electric field intensity in the arrangement direction Y can be suppressed. Furthermore, by configuring the electric field adjusting member 150 from a composite of the electric conductor and the insulator having a relative permittivity of 1.0 or more, both of the above functions can be obtained by the conductor and the insulator, thereby increasing the electric field intensity in the region where the electric field adjusting member 150 is arranged and suppressing the variation in the electric field intensity in the arrangement direction Y.

Examples of the above conductors and insulators that make up the electric field adjusting member 150 include metals, ceramics, and resins. These may be used alone or in combination of two or more. By using such materials, the electric field adjusting member 150 can be easily produced.

Preferably, the dielectric drying device 100 further includes a drive mechanism capable of moving the position of the electric field adjusting member 150. By including such a drive mechanism, the position of the electric field adjusting member 150 can be moved depending on the drying states of the ceramic formed bodies 10, thereby more stably suppressing variations in the drying states of the plurality of ceramic formed bodies 10 in the arrangement direction Y. More particularly, the drying states of the ceramic formed bodies 10 after dielectric drying are measured, and the position of the electric field adjusting member 150 (e.g., one or more positions in the conveying direction X, the arrangement direction Y, and the vertical direction Z) is moved by the drive mechanism based on that measurement results, so that the electric field intensity in the region where the electric field adjusting member 150 is present can be finely adjusted.

The drive mechanism is not particularly limited as long as it can adjust the position of the electric field adjusting member 150, and examples include motors, air jacks, and other known components. These drive mechanisms may be connected directly to the electric field adjusting member 150, or indirectly via connecting members.

The connection position of the drive mechanism in the electric field adjusting member 150 is not particularly limited as long as the position does not interfere with the dielectric drying. For example, the drive mechanism can be connected to the side of the electric field adjusting member 150.

The number of the plurality of ceramic formed bodies 10 placed on the drying table 20 may be appropriately adjusted depending on the size of the drying table 20, and the like. It is preferably from 2 to 5, and more preferably 3 to 5.

The sizes of the plurality of ceramic formed bodies 10 placed on the drying table 20 are not particularly limited. It is preferable that lengths of them in the vertical direction Z are substantially the same, and it is more preferable that lengths of them in all directions are substantially the same.

Both the upper electrode 130 and the lower electrode 140 use a known electrode plate. Further, the upper electrode 130 can be processed by a known method to form it into a desired shape.

Auxiliary electrodes may be placed on upper end surfaces 11a of the plurality of ceramic formed bodies 10. The placing of the auxiliary electrodes can result in uniform electric field intensity on the upper end surfaces 11a of the ceramic formed bodies 10 which would otherwise tend to generate non-uniform electric field intensity during dielectric drying. This can bring about a uniform heating amount of the ceramic formed bodies 10 as a whole to reduce uneven drying.

A material of each auxiliary electrode is not particularly limited. It is preferable that the material has a conductivity higher than that of the ceramic formed body 10. If it has such a conductivity, a function as the auxiliary electrode 30 can be sufficiently ensured. Examples of the material of the auxiliary electrode 30 include aluminum, copper, aluminum alloys, copper alloys, graphite and the like. These can be used alone or in combination of two or more.

As the auxiliary electrode, for example, a perforated plate can be used.

As used herein, the “perforated plate” means a plate material having openings.

A perforation ratio of the perforated plate is preferably from 20 to 90%, and more preferably from 40 to 80%, although not particularly limited thereto. The controlling of the perforation ratio within such a range can result in a uniform electric field intensity of the ceramic formed body 10 on the upper end surface 11a, which would otherwise tend to generate a non-uniform electric field intensity during dielectric drying. This can bring about a uniform heating amount of the ceramic formed bodies 10 as a whole to reduce uneven drying.

As used herein, the “perforation ratio of the perforated plate” means a ratio of perforated areas to the total area of the surface of the perforated plate, which is in contact with the upper end surface 11a of the ceramic formed body 10.

The openings on the surface of the perforated plate in contact with the upper end surface 11a of the ceramic formed body 10 may have various shapes, including, but not limited to, a circular shape, a quadrangular shape, and a slit shape.

The drying table 20 on which the ceramic formed bodies 10 are placed is not particularly limited. It is preferable to have the perforated plates at portions in contact with lower end surfaces 11b of the plurality of ceramic formed bodies 10. Such a configuration can allow water vapor to be easily removed from the lower end surfaces 11b of the ceramic formed bodies 10 during dielectric drying, so that the ceramic formed bodies 10 can be easily and uniformly dried.

Non-limiting examples of a material of the perforated plate include aluminum, copper, aluminum alloy, copper alloy, and graphite. These can be used alone or in combination of two or more.

The perforation ratio and the shape of the openings of the perforated plate used in the drying table 20 are not particularly limited. They may be the same as those of the perforated plate used in the auxiliary electrode 30.

Various conditions (frequency, output, heating time, and the like) during dielectric drying may be appropriately set depending on objects to be dried (ceramic formed bodies 10), types of the dielectric drying device 100, and the like. For example, the frequency during dielectric drying is preferably from 10 MHz to 100 MHz.

The ceramic formed bodies 10 to be subjected to dielectric drying preferably have a water content of from 1 to 60%, and more preferably from 5 to 55%, and even more preferably from 10 to 50%, although not limited thereto. The ceramic formed bodies 10 in such a range of the water content tend to vary in the dried states during dielectric drying. Therefore, the effect of the present invention can be more easily obtained by using the ceramic formed bodies 10 having the water content in such a range.

As used herein, the water content of the ceramic formed bodies 10 means a water content measured by an infrared heating type moisture meter.

The ceramic molded body 10 is preferably a honeycomb formed body including a partition wall that defines a plurality of cells extending from a first end face to a second end face, although not particularly limited thereto.

A cell shape of the honeycomb formed body (cell shape in a cross section orthogonal to a cell extending direction) is not particularly limited. Examples of the cell shape include a triangle, a quadrangle, a hexagon, an octagon, a circle or a combination thereof.

Examples of a shape of the honeycomb formed body include, but not limited to, a cylindrical shape, an elliptical pillar shape, and a polygonal pillar shape having a square, rectangular, triangular, pentagonal, hexagonal, and octagonal end faces.

The ceramic formed body 10 can be obtained by molding a green body obtained by kneading a raw material composition containing a ceramic raw material and water.

The ceramic raw material that can be used includes, but not particularly limited to, cordierite-forming raw materials, cordierite, silicon carbide, silicon-silicon carbide composite materials, mullite, aluminum titanate, and the like. These can be used alone or in combination of two or more. The cordierite-forming raw material is a ceramic raw material formulated so as to have a chemical composition in which silica is in the range of from 42 to 56% by mass, alumina is in the range of from 30 to 45% by mass, and magnesia is in the range of from 12 to 16% by mass. The cordierite-forming raw material is calcined to form cordierite.

The raw material composition may contain a dispersion medium, a binding material (for example, an organic binder, an inorganic binder, or the like), a pore former, a surfactant, and the like, in addition to the ceramic raw material and water. A composition ratio of each raw material preferably depends on the structures, materials, and the like of the ceramic formed bodies 10 to be produced, but not particularly limited.

A method of kneading the raw material composition to form the green body can use, for example, a kneader, a vacuum green body kneader, or the like. Further, a method of forming the ceramic formed body 10 can employ, for example, a known molding method such as extrusion molding and injection molding. Specifically, when the honeycomb formed body is produced as the ceramic formed body 10, the extrusion molding may be performed using a die having a desired cell shape, partition wall (cell wall) thickness, and cell density. Examples of a material of the die that can be used include hard metal alloys that are difficult to wear.

In the dielectric drying method and the dielectric drying device 100 for the ceramic formed bodies 10 according to the embodiment of the present invention, the at least one electric field adjusting member 150 is arranged below the drying table 20 that is not supported by the conveyer belt, so that the electric field intensity in the arrangement direction Y can be of the same degree. Therefore, it is possible to suppress variations in the dried states of the plurality of ceramic formed bodies 10 in the arrangement direction Y.

### (2) Method for Producing Ceramic Structures

The method for producing ceramic structures according to the embodiment of the present invention includes the above dielectric drying method for the ceramic formed bodies 10.

In the method for producing the ceramic structures according to the embodiment of the present invention, steps other than the above dielectric drying method are not particularly limited, and steps known in the art can be applied. Specifically, the method for producing the ceramic structures according to the embodiment of the present invention can further include a firing step of drying the ceramic formed bodies 10 using the above dielectric drying method to obtain ceramic dried bodies, and firing the ceramic dried bodies to obtain ceramic structures.

A method for firing the ceramic dried bodies is not particularly limited, and for example, the ceramic dried bodies may be fired in a firing furnace. Further, for the firing furnace and firing conditions, known conditions can be appropriately selected depending on the outer shapes, materials, and the like of the honeycomb structures to be produced. Prior to firing, organic substances such as a binder may be removed by calcination.

Since the method for producing the ceramic structures according to the embodiment of the present invention includes the dielectric drying method capable of suppressing variations in the dried states of the plurality of ceramic formed bodies 10 in the arrangement direction Y, the ceramic structures having a uniform shape can be produced.

### EXAMPLES

Hereinafter, the present invention will be described in more detail with reference to Examples, but the present invention is not limited to these Examples.

### Example 1

### (Production of Ceramic Formed Bodies)

Honeycomb formed bodies were produced as ceramic formed bodies. First, A cordierite-forming raw material obtained by mixing alumina, kaolin and talc as a ceramic raw material was mixed with a binding material containing an organic binder, a water-absorbent resin as a pore former, and water as a dispersion medium to form a raw material composition, which was kneaded to provide green bodies. Each of the resulting green bodies was extruded to obtain a honeycomb formed body including cells each having a square cross-sectional shape orthogonal to the extending direction of the cells. The honeycomb formed body had an outer diameter (diameter) of 140 mm, a length (length in the extending direction of the cells) of 200 mm, and an outer shape that was a cylindrical shape. Further, the honeycomb formed bodies had a water content of 40%. The water content and weight of the honeycomb formed bodies are average values of all the produced honeycomb formed bodies.

### (Dielectric Drying of Ceramic Formed Bodies)

Dielectric drying was carried out using the ceramic formed bodies (honeycomb formed bodies) produced above. Specifically, the following procedure was used:

Five ceramic formed bodies were placed side by side in the arrangement direction Y on the upper surface of the drying table (with a thickness of 10 mm) having an aluminum perforated plate (with a perforation ratio of 60% and a thickness of 2 mm) at a portion that was in contact with the lower end faces of the honeycomb formed bodies, and auxiliary electrodes (aluminum perforated plates each having a perforation ratio of 60% and a thickness of 2 mm) were placed on the upper end faces of the five ceramic molded bodies. Thus, nine drying tables in total, each on which the five ceramic formed bodies were placed, were prepared.

A dielectric drying device (FIG. 2) equipped with two conveyor belts (having a thickness of 20 mm and a length in the arrangement direction Y of 190 mm) supporting the vicinity of both ends of the drying table in the arrangement direction Y was used as the dielectric drying device. Nine drying tables on which five honeycomb formed bodies were arranged were placed on the conveyor belts of the dielectric drying device, and three electric field adjusting members (aluminum plates each having a thickness of 15 mm and a length in the arrangement direction Y of 190 mm) were placed below the drying table that was not supported by the conveyor belts (FIG. 2). It should be noted that the distance between the auxiliary electrode and the upper electrode in the vertical direction was 100 mm.

The dielectric drying was carried out by operating the conveyer belts in the conveying direction X, and conveying the honeycomb formed bodies placed on the drying tables into the dielectric drying furnace. The conditions for the dielectric drying were a frequency of 40.68 MHz (ISM band), an output of 85.0 kW, and a heating time of 12 minutes.

### Comparative Example 1

The dielectric drying of the honeycomb formed bodies was carried out by the same method as that of Example 1, with the exception that the electric field adjusting member was not arranged below the drying table that was not supported by the conveyor belts.

### (Calculation of Heating Amount)

First, each of the ceramic formed bodies placed side by side in the arrangement direction Y was analyzed by a simulation using the differential time domain method (FDTD method). In the simulation, the electric field intensity E at each lattice point in the ceramic formed body was determined.

The heating amount H at each lattice point was then calculated from the obtained electric field intensity E from the following equation (1):

$$\begin{matrix}[ Equation 1 ] & \\ H = \frac{1}{2} ωε tan δ {\vert E \vert}^{2} & ( 1 )\end{matrix}$$

In the equation (1), w is an angular frequency (2π×40 MHz), ε is a dielectric constant of the ceramic formed body, and tan δ is a dielectric loss tangent of the ceramic formed body.

The heating amounts H at the lattice points in the respective ceramic formed bodies were then totaled to calculate the total heating amount of the respective ceramic formed bodies. The total heating amounts of the five ceramic formed bodies from the left end to the right end in the arrangement direction Y were defined as H1 to H5 in this order, and the heat amount distribution ratio was obtained by the following equation (2):

Heating amount distribution ratio (%)=total heating amount at each position/sum of total heating amounts at all positions×100 (2)

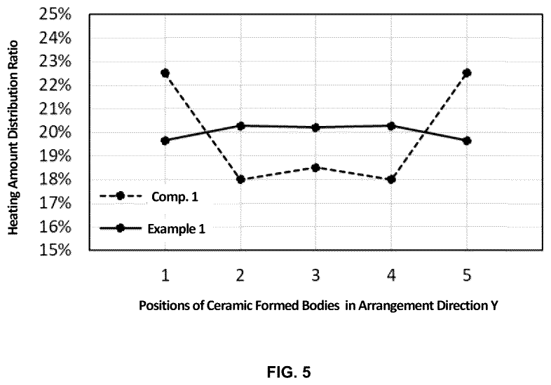

The results are shown in FIG. 5. In FIG. 5, the positions of the five ceramic formed bodies from the left end to the right end in the arrangement direction Y are represented by 1 to 5 on the X axis.

As shown in FIG. 5, Example 1 where dielectric drying was carried out by placing the electric field adjusting members below the drying tables that were not supported by the conveyor belts had less variations in the drying states of the ceramic formed bodies in the arrangement direction Y than Comparative Example 1 where the dielectric drying was carried out without placing any electric field adjusting member below the drying table that was not supported by the conveyor belts. Specifically, in Comparative Example 1, the difference in the heating amount distribution ratios between the ceramic formed body at the central portion and the ceramic formed bodies at both ends was about 5%, whereas in Example 1, the difference in the heating amount distribution ratios could be suppressed to less than 1%.

As can be seen from the above results, according to the present invention, it is possible to provide a dielectric drying method and a dielectric drying device for ceramic formed bodies, which can suppress variations in the dried states of a plurality of ceramic formed bodies placed on the drying table, in the arrangement direction Y perpendicular to the conveying direction X. Further, according to the present invention, it is possible to provide a method for producing ceramic structures capable of making the ceramic structures having a uniform shape.

### DESCRIPTION OF REFERENCE NUMERALS

10, 10a, 10b ceramic formed body
11a upper surface
11b lower surface
20 drying table
100 dielectric drying device
110 dielectric drying furnace
120 conveyer
121 conveyer belt
130 upper electrode
140 lower electrode
150 electric field adjusting member

1. A dielectric drying method for ceramic formed bodies, the method comprising drying a plurality of ceramic formed bodies placed side by side in an arrangement direction Y perpendicular to a conveying direction X on an upper surface of a drying table by conveying the ceramic formed bodies between electrodes of an upper electrode and a lower electrode, and applying a high frequency between the electrodes,
wherein the drying table is conveyed by a conveyor having at least one conveyor belt for supporting a portion of the drying table in the arrangement direction Y; and
wherein at least one electric field adjusting member is arranged below the drying table that is not supported by the conveyor belt.

2. The dielectric drying method for ceramic formed bodies according to claim 1, wherein the electric field adjusting member is a plate material having a thickness of more than or equal to 20% and less than 100% of a thickness of the conveyor belt.

3. The method dielectric drying for ceramic formed bodies according to claim 1, wherein the electric field adjusting member is arranged in a region corresponding to an upper position of the ceramic formed bodies in a vertical direction Z.

4. The dielectric drying method for ceramic formed bodies according to claim 1, wherein the electric field adjusting member comprises one or more selected from conductors and insulators having a relative permittivity of 1.0 or more.

5. The dielectric drying method for ceramic formed bodies according to claim 4, wherein the electric field adjusting member is made of one or more selected from metals, ceramics and resins.

6. The dielectric drying method for ceramic formed bodies according to claim 1, wherein a position of the electric field adjusting member is moved depending on drying states of the ceramic formed bodies.

7. The dielectric drying method for ceramic formed bodies according to claim 1, wherein each of the ceramic formed bodies has a water content of 1 to 60%.

8. The dielectric drying method for ceramic formed bodies according to claim 1, wherein the ceramic formed bodies are honeycomb formed bodies, each of the honeycomb formed bodies comprising a partition wall that defines a plurality of cells each extending from a first end face to a second end face.

9. A method for producing ceramic structures, comprising the dielectric drying method for the ceramic formed bodies according to claim 1.

10. A dielectric drying device for ceramic formed bodies, the device comprising:
an upper electrode;
a lower electrode; and
a conveyer comprising at least one conveyer belt for supporting a portion of a drying table on which a plurality of ceramic formed bodies are placed side by side in an arrangement direction Y perpendicular to a conveying direction X, the conveyer being capable of conveying the plurality of ceramic formed bodies between electrodes of the upper electrode and the lower electrode by the conveyer belt; and
at least one electric field adjusting member arranged below the drying table that is not supported by the conveyor belt.

11. The dielectric drying device according to claim 10, wherein the electric field adjusting member is a plate material having a thickness of more than or equal to 20% and less than 100% of a thickness of the conveyor belt.

12. The dielectric drying device according to claim 10, wherein the electric field adjusting member is arranged in a region corresponding to an upper position of the ceramic formed bodies in a vertical direction Z.

13. The dielectric drying device according to claim 10, wherein the electric field adjusting member comprises one or more selected from conductors and insulators having a relative permittivity of 1.0 or more.

14. The dielectric drying device according to claim 13, wherein the electric field adjusting member is made of one or more selected from metals, ceramics and resins.

15. The dielectric drying device according to claim 10, further comprising a drive mechanism capable of moving a position of the electric field adjusting member.
